(19) United States
(12) Patent Application Publication
(10) Pub. No.: US 2017/0131136 A1
(43) Pub. Date: May 11, 2017

(54) WATER-PROOF ELECTRONIC SCALE DEVICE

(71) Applicant: Dalman (Import & Export) Ltd, Bucks (GB)

(72) Inventors: Jessica Nugent, Bucks (GB); Huan Ma, Shenzhen (CN)

(21) Appl. No.: 14/938,275

(22) Filed: Nov. 11, 2015

(51) Int. Cl. G01G 21/28

(52) U.S. Cl. CPC G01G 21/28

(57) ABSTRACT

A new waterproof electronic scale device is proposed, which includes a casing/body/frame and a plurality of internal components and/or circuitries encapsulated within the casing of the electronic scale device. At least a portion of the internal components are coated with a layer of polymer nanometer (or nano) water-resistant material, which is water and oil proof. The layer of nano-coating material is so applied to the surface of the internal components that it effectively protects the coated internal components from being damaged by liquid infiltration, such as infiltration by moisture or oil content, into the electronic scale device.

### BACKGROUND

An electronic scale device is a weighing device/apparatus that utilizes load sensor technology, electronic technology, and computer technology to collect, process, and display the weight of an object or human being. Due to its many advantages, such as its compact structure, light weight, easy to carry, easy to use, fast response, and high sensitivity, the electronic scale, such as the weight scale and the kitchen scale, has become an indispensable instrument used in many shops and families.

Since the weight scales and the kitchen scales are often placed in environments having heavy presence of moisture/water (e.g., bathrooms) and oil (e.g., kitchens), respectively, infiltration of moisture or oil contents into the electronic scales is likely, which may cause severe damages to the circuitries inside the electronic scales. In order to protect the internal circuitry of the electronic scales from the infiltration of the moisture or oil contents, users of the electronic scales need to carefully isolate the electronic scales from any water and oil sources when using them in kitchens and bathrooms, which may cause certain degree of inconvenience to the users.

In order to improve the users' experiences with the electronic scales in environments having heavy presence of water and oil, waterproofing the electronic scales has become an important issue for scale manufacturers. Some current waterproofing approaches adopted for an electronic scale place the internal circuitry of the scale in a physically sealed environment/space/container, which cannot be infiltrated easily by either water or oil. Although such physically sealed environment may protect the internal circuitry of the electronic scale to a certain extent, it often results in more complicated device structure and/or larger physical space occupied by the electronic scale. An effective waterproofing approach to the electronic scale that does not result in increase in its structural complexity and size is desired.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1(a) depicts an example of a schematic diagram of an internal structure of a first embodiment of a waterproof electronic scale device in accordance with some embodiments.

FIG. 1(b) depicts an example of a front view of the first embodiment of the waterproof electronic scale device depicted in FIG. 1(a) in accordance with some embodiments.

FIG. 1(c) depicts an example of a back view of the first embodiment of the waterproof electronic scale device depicted in FIG. 1(a) in accordance with some embodiments.

FIG. 2(a) depicts an example of a schematic diagram of an internal structure of a second embodiment of a waterproof electronic scale device in accordance with some embodiments.

FIG. 2(b) depicts an example of a front view of the second embodiment of the waterproof electronic scale device depicted in FIG. 2(a) in accordance with some embodiments.

FIG. 2(c) depicts an example of a back view of the second embodiment of the waterproof electronic scale device depicted in FIG. 2(a) in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new waterproof electronic scale device is proposed, which includes a casing/body/frame and a plurality of internal components and/or circuitries encapsulated within the casing of the electronic scale device. At least a portion of the internal components are coated with a layer of polymer nanometer (or nano) water-resistant material, which is water and oil proof. The layer of nano-coating material is so applied to the surface of the internal components that it effectively protects the coated internal components from being damaged by liquid infiltration, such as infiltration by moisture or oil content, into the electronic scale device.

For the proposed waterproof electronic scale device, applying the layer of nano-coating material on the surfaces of the internal components of the electronic scale device does not require any other changes to the existing components and/or structure of the electronic scale device. As such, the proposed water-proof electronic scale device prevents damages to the electronic scale device due to moisture or oil without causing any increase in the structural complexity or the physical size/space occupied by the electronic scale device.

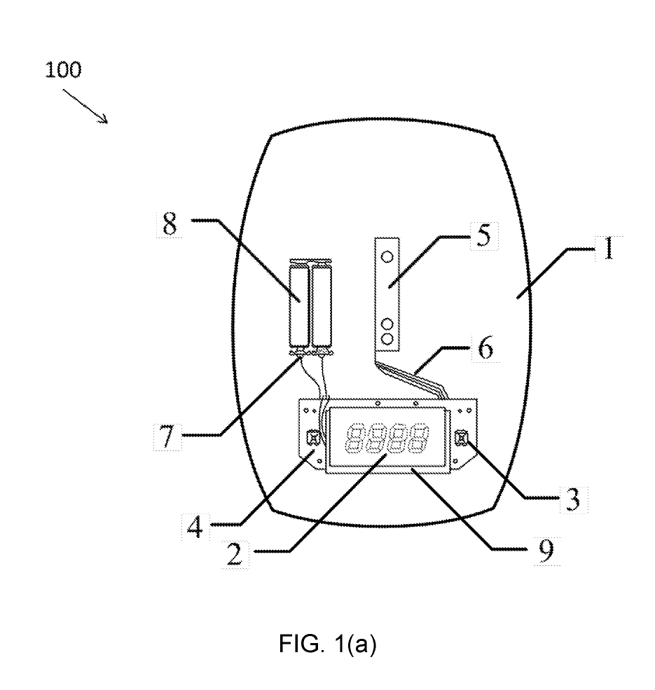

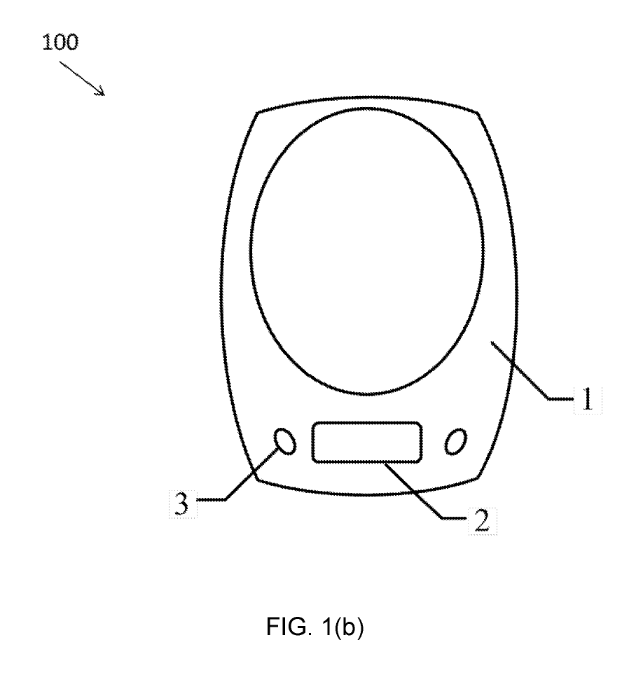

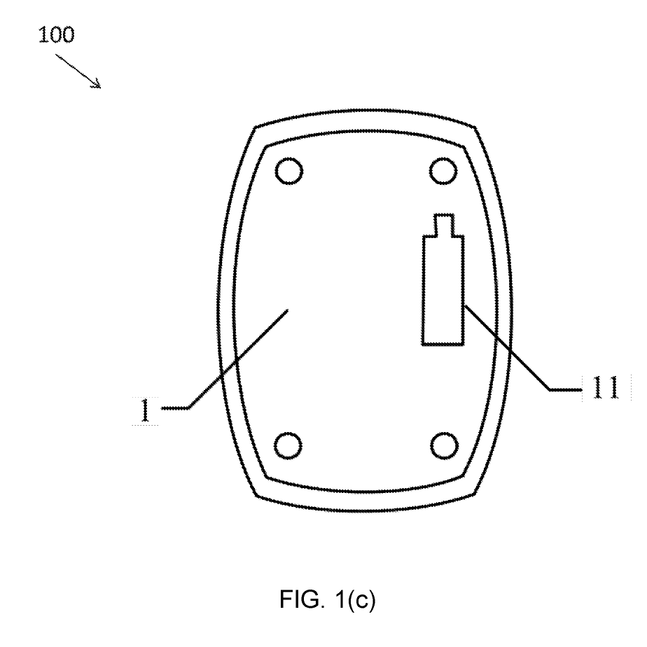

FIGS. 1(a)-(c) depict an example of a first embodiment of a waterproof electronic scale device 100 in accordance with some embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

FIG. 1(a) depicts an example of a schematic diagram of an internal structure of the first embodiment of the waterproof electronic scale device 100. As shown in of FIG. 1(a), the waterproof electronic scale device 100 includes one or more of the following components: a casing 1 configured to encapsulate a plurality of internal components of the electronic scale device 100, a display (screen) 2 located on the casing 1 and configured to present weight data/result of the object on and/or status information of the electronic scale device 100 to a user of the device, one or more buttons 3 located on the casing 1 and configured to be pressed by a user of the waterproof electronic scale device 100 to turn on/off, reset, and/or operate the electronic scale device 100, an electronic circuitry, e.g., printed circuit board (PCB) 4, configured to process weight data collected from sensors 5 and provide the processed weight data for display by the display 2, said one or more sensors 5 configured to detect and collect the weight data of an object on the electronic scale device 100 and provide collected weight data to the PCB 4 for processing, electrical wirings 6 for data and signal transmission between the PCB 4 and the sensors 5, battery electrode contacts 7 connecting to the PCB 4, one or more batteries 8 in a battery case to power the internal components, and backlight panel 9 for the display 2. FIGS. 1(b) and 1(c) depict examples of a front and a back view of the first embodiment of the waterproof electronic scale device depicted in FIG. 1(a), respectively, wherein a battery case cover/lid 11 attached to the casing 1 and operatively open or close over the battery case is shown in FIG. 1(c).

In some embodiments, each of the one or more sensors 5 is a load cell, which is s a transducer that converts an input mechanical force by an object or a human being on the electronic scale device 100 into an electrical output signal or the weight data. In the example depicted in FIG. 1(a), there is only one sensor 5 centrally located inside the casing 1 in the first embodiment of a waterproof electronic scale device 100, wherein the sensor 5 connects to the PCB 4 via the electrical wirings 6. Additionally, the batteries 8 can be cylindrical in shape as shown in FIG. 1(a).

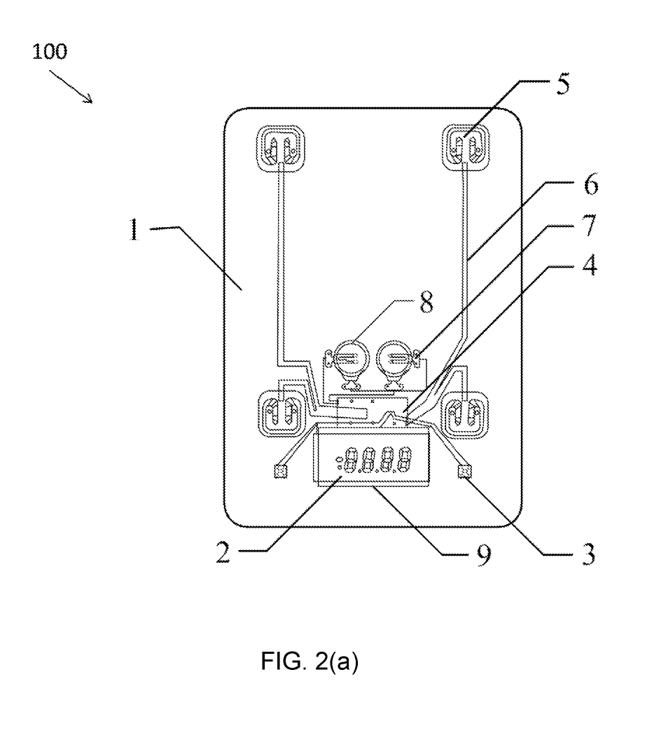

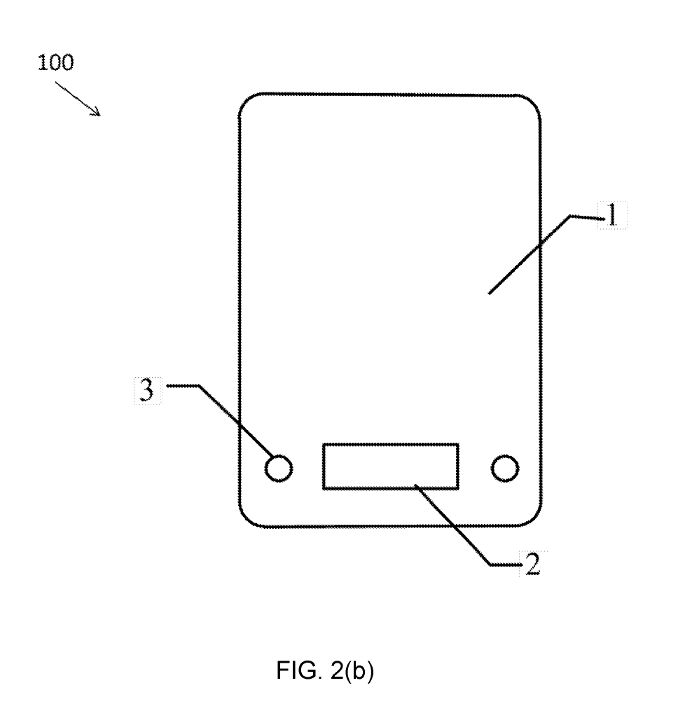

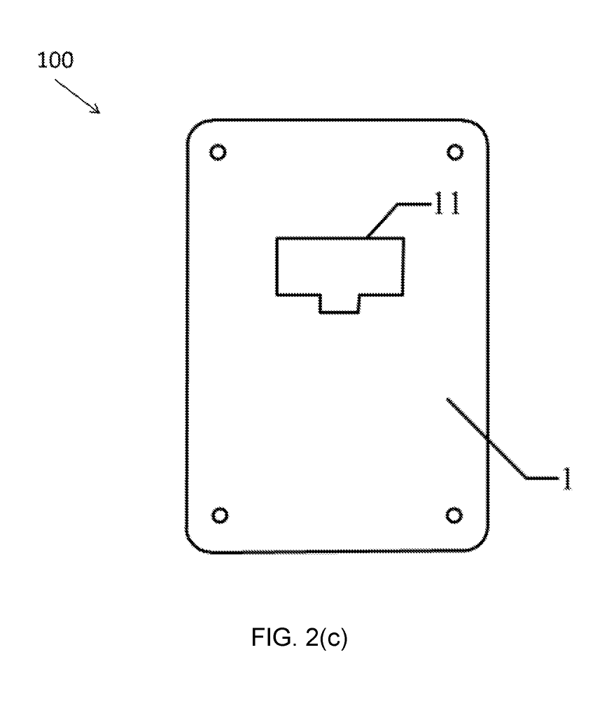

FIGS. 2(a)-(c) depict an example of a second embodiment of the waterproof electronic scale device 100 in accordance with some embodiments, wherein FIG. 2(a) depicts an example of a schematic diagram of an internal structure of the second embodiment of the waterproof electronic scale device 100, and FIGS. 2(b) and 2(c) depict examples of a front and a back view of the second embodiment of the waterproof electronic scale device depicted in FIG. 2(a), respectively. Compared to the first embodiment of the waterproof electronic scale device 100 depicted in FIGS. 2(a)-(c), there are multiple (e.g., 4 as shown in FIG. 2(a)) sensors 5 located at various locations (e.g., corners) inside the casing 1 of the waterproof electronic scale device 100, wherein each of the sensors 5 connects to the PCB 4 via their respective electrical wirings 6. Additionally, the batteries 8 can be button-shaped as shown by the example in FIG. 2(a).

In some embodiments the waterproof electronic scale device 100 can be but is not limited to one of a kitchen electronic scale (e.g., in a kitchen), a human electronic scale (e.g., in a bathroom), a jewelry electronic scale, a lifting hook electronic scale, a pocket electronic scale, and a parcel electronic scale in various home, commercial, and/or industrial environments.

In the example of the first and the second embodiment of the waterproof electronic scale device 100 shown in FIGS. 1(a)-(c) and 2(a)-(c), surfaces of at least a portion of the internal components of the electronic scale device 100 are coated with a layer of polymer nanometer water-resistant material (not shown), which is water and oil proof. Here, the layer of the polymer nanometer water-resistant material is super thin, which is, for a non-limiting example, less than one thousandth of the thickness of a human hair and is thus invisible to naked human eyes. Since the layer of the polymer nanometer water-resistant material is invisible, the external appearances of the waterproof electronic scale device 100 looks no different from that of a conventional electronic scale device.

In some embodiments, the internal components of the waterproof electronic scale device 100 to be coated is placed in a vacuum environment and the polymer nanometer water-resistant material is evenly sprayed on the surface of the internal components to form an uniformly-distributed layer of the polymer nanometer water-resistant material that fully covers the internal components. In some embodiments, the layer of the polymer nanometer water-resistant material can permeate into any and every place of the internal components it coats or covers, including but not limited to welding points and gaps in the internal components.

Since the molecular density of the polymer nanometer water-resistant material is much lower than that of the molecular density of oil, in some embodiments, the layer of the polymer nanometer water-resistant material can prevent the oil that touches it from penetrating into the internal components it covers by forming an oleophobic layer that repels and disperses the oil. Similarly, since the spacing between the nanometer molecules is much lower than the spacing between hydro-molecules, in some embodiments, the layer of the polymer nanometer water-resistant material can prevent water/moisture that touches it from penetrating into the internal components it covers by forming a hydrophobic layer that that repels and disperses the ingress of water.

In some embodiments, the internal components of the waterproof electronic scale device 100 coated by the layer of the polymer nanometer water-resistant material include the PCB 4 and the sensors 5 electrically connected to the PCB 4 inside the casing 1 of the waterproof electronic scale device 100. Here, the PCB 4 and/or the sensors 5 may get short-circuited and damaged permanently when they are wet if they were not nano-coated. Since the layer of the polymer nanometer water-resistant material is water and oil repellent, any small water or oil drops on the coated PCB 4 and/or the sensors 5, which may cause wrong readings due to change in electric current through them, can be easily driven off with a shake of the waterproof electronic scale device 100.

In some embodiments, the coated internal components of the waterproof electronic scale device 100 include the battery electrode contacts 7, wherein the battery electrode contacts 7 connect to the PCB 4 through electrical wirings. Here, the battery electrode contacts 7 include contacts for connecting to anode and cathode of the batteries 8, respectively.

In some embodiments, the coated internal components of the waterproof electronic scale device 100 include the batteries 8 inside the battery case cover 11, wherein the batteries connect electrically to the PCB 4 via the battery electrode contacts 7.

In some embodiments, the coated internal components of the waterproof electronic scale device 100 include the display 2 located on the casing 1 and electrically connected with the PCB 4, wherein the display 2 is configured to present weight data/result of an object on and/or status information of the electronic scale device 100 to a user of the device.

In some embodiments, the coated internal components of the waterproof electronic scale device 100 include the buttons 3 located on the casing 1 and electrically connected with the PCB 4. Here, the buttons 3 include power on/off switch and/or control button of the waterproof electronic scale device 100.

In some embodiments, the coated internal components of the waterproof electronic scale device 100 include each of the display 2, the buttons 3, the PCB 4, the sensors 5, electrical wirings 6, the battery electrode contacts 7, the batteries 8 and all of the connecting wires among these components in order to achieve the optimal water and oil proofing effect for the waterproof electronic scale device 100.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A waterproof electronic scale device, comprising:
a casing configured to encapsulate a plurality of internal components of the electronic scale device;
said plurality of internal components including at least
one or more sensors configured to detect and collect weight data of an object on the electronic scale device and provide the collected weight data to an electronic circuitry for processing;
said electronic circuitry configured to process the weight data collected from the sensors and provide the processed weight data for display;
wherein surfaces of at least a portion of the internal components are coated with a layer of polymer nanometer water-resistant material, which is water and oil proof.

2. The scale device of claim 1, wherein:
the waterproof electronic scale device is one of a kitchen electronic scale, a human electronic scale, a jewelry electronic scale, a lifting hook electronic scale, a pocket electronic scale, and a parcel electronic scale in various home, commercial, and/or industrial environments.

3. The scale device of claim 1, wherein:
the electronic circuitry is a printed circuit board (PCB).

4. The scale device of claim 1, wherein:
each of the one or more sensors is a load cell, which is a transducer that converts an input mechanical force by an object or a human being on the electronic scale device into the weight data.

5. The scale device of claim 1, wherein:
there is only one sensor centrally located inside the casing of the waterproof electronic scale device.

6. The scale device of claim 1, wherein:
there are multiple sensors located at various locations inside the casing of the waterproof electronic scale device.

7. The scale device of claim 1, wherein:
coating the layer of the polymer nanometer water-resistant material on the surfaces of the internal components of the electronic scale device does not require any other changes to the internal components of the electronic scale device.

8. The scale device of claim 1, wherein:
the layer of the polymer nanometer water-resistant material is configured to prevent damages to the electronic scale device due to moisture or oil without causing any increase in structural complexity or physical size/space occupied by the electronic scale device.

9. The scale device of claim 1, wherein:
the layer of the polymer nanometer water-resistant material is invisible to naked human eyes.

10. The scale device of claim 1, wherein:
the layer of the polymer nanometer water-resistant material is less than one thousandth of the thickness of a human hair.

11. The scale device of claim 1, wherein:
the layer of the polymer nanometer water-resistant material is uniformly-distributed and permeates into any and every place of the internal components it coats.

12. The scale device of claim 1, wherein:
the layer of the polymer nanometer water-resistant material prevents oil that touches it from penetrating into the internal components it covers by forming an oleophobic layer that repels and disperses the oil.

13. The scale device of claim 1, wherein:
the layer of the polymer nanometer water-resistant material prevents water or moisture that touches it from penetrating into the internal components it covers by forming a hydrophobic layer that that repels and disperses the ingress of the water or moisture.

14. The scale device of claim 1, wherein:
the internal components of the waterproof electronic scale device coated by the layer of the polymer nanometer water-resistant material include the electronic circuitry and the sensors electrically connected to the electronic circuitry inside the casing of the waterproof electronic scale device.

15. The scale device of claim 14, wherein:
the coated internal components of the waterproof electronic scale device further include a plurality of battery electrode contacts, wherein the battery electrode contacts connect to the electronic circuitry through electrical wirings.

16. The scale device of claim 15, wherein:
the coated internal components of the waterproof electronic scale device further include a plurality of batteries inside a battery case, wherein the batteries connect electrically to power the electronic circuitry via the battery electrode contacts.

17. The scale device of claim 14, wherein:
the coated internal components of the waterproof electronic scale device further include a display located on the casing of the waterproof electronic scale device and electrically connected with the electronic circuitry, wherein the display is configured to present the weight data of an object and/or status information of the electronic scale device to a user of the device.

18. The scale device of claim 14, wherein:
the coated internal components of the waterproof electronic scale device further include one or more buttons located on the casing and electrically connected with the electronic circuitry, wherein the buttons are configured to be pressed by a user to turn on/off, reset, and/or operate the of the waterproof electronic scale device.

19. The scale device of claim 1, wherein:
the coated internal components of the waterproof electronic scale device include each of a display, one or more buttons, the electronic circuitry, the sensors, electrical wirings, a plurality of battery electrode contacts and batteries, and all connecting wires among these components to achieve the optimal water and oil proofing effect for the waterproof electronic scale device.

20. A waterproof electronic scale device, comprising:
a casing configured to encapsulate a plurality of internal components of the electronic scale device;
said plurality of internal components including at least
a plurality of sensors configured to detect and collect weight data of an object on the electronic scale device and provide the collected weight data to a printed circuit board (PCB) for processing;
said PCB configured to process the weight data collected from the sensors and provide the processed weight data for display;
wherein surfaces of at least plurality of sensors, the PCB, and the wiring between them are coated with a layer of polymer nanometer water-resistant material, which is water and oil proof.
